(19) United States
(12) Patent Application Publication
(10) Pub. No.: US 2019/0082396 A1
(43) Pub. Date: Mar. 14, 2019

(54) METHOD AND/OR SYSTEM FOR PROCESSING POWER CONTROL SIGNALS

(71) Applicant: QUALCOMM Incorporated, San Diego, CA (US)

(72) Inventors: Ankit Maheshwari, Hyderabad (IN); Stephen William Edge, Escondido, CA (US); Shruti Agrawal, Hyderabad (IN)

(21) Appl. No.: 15/705,091

(22) Filed: Sep. 14, 2017

(51) Int. Cl. H04W 52/28; H04W 52/54

(52) U.S. Cl. CPC H04W 52/283; H04W 52/54; H04W 52/285; H04W 52/282

(57) ABSTRACT

Methods and systems are disclosed for processing control messages transmitted from multiple base stations and received at a mobile device. The mobile device may have wireless access using LTE or NR carrier aggregation and may be enabled to send uplink communication to multiple base stations. In a particular implementation, transmission power control (TPC) parameters transmitted by the multiple base stations and received at the mobile device may be processed to determine one or more aspects of motion of the mobile device such as a direction of motion, distance of motion and/or a location of the mobile device.

### BACKGROUND

### Field

Subject matter disclosed herein relates to processing messages received at a mobile device from a Radio Access Network for use in positioning operations.

Information:

The location of a mobile device, such as a cellular telephone, may be useful or essential to a number of applications including emergency calls, navigation, direction finding, asset tracking and Internet service. The location of a mobile device may be estimated based on information gathered from various systems. In a cellular network implemented according to 4G (also referred to as Fourth Generation) Long Term Evolution (LTE) radio access, for example, a base station may transmit a positioning reference signal (PRS). A mobile device may process a PRS transmitted by multiple base stations in a network to obtain measurements indicative of a location of the mobile device. Also, a mobile device may obtain measurements indicative of a location of the mobile device by processing satellite positioning system (SPS) signals. However, there may be scenarios where PRS signals and SPS signals (and other positioning related signals) are not available at the location of a mobile device or are available but with an insufficient number of signals or insufficient quality of signals to enable a mobile device to be located or to be accurately located. In such scenarios, other methods of locating a mobile device may be useful or necessary.

### SUMMARY

Briefly, one particular implementation is directed to a method at a mobile device comprising: transmitting first messages to a plurality of base stations; receiving second messages from the plurality of base stations, the second messages comprising transmission power control (TPC) parameters, the TPC parameters being based, at least in part on measurements of received signal power for the first messages obtained at the base stations; and determining one or more parameters indicative of a first motion of the mobile device based, at least in part, on the TPC parameters.

Another particular implementation is directed to a mobile device comprising a transceiver to transmit messages to and receive messages from a communication network; and one or more processors configured to: initiate transmission of first messages to a plurality of base stations; obtain from second messages received at the transceiver from the plurality of base stations transmission power control (TPC) parameters, the TPC parameters being based, at least in part on measurements of received signal power for the first messages obtained at the base stations; and determine one or more parameters indicative of a first motion of the mobile device based, at least in part, on the TPC parameters.

Another particular implementation is directed to a storage medium comprising computer readable instructions stored thereon which are executable by one or more processors of a mobile device to: initiate transmission of first messages to a plurality of base stations; obtain from second messages received at the mobile device from the plurality of base stations transmission power control (TPC) parameters, the TPC parameters being based, at least in part on measurements of received signal power for the first messages obtained at the base stations; and determine one or more parameters indicative of a first motion of the mobile device based, at least in part, on the TPC parameters.

Another particular implementation is directed to a mobile device, comprising: means for transmitting first messages to a plurality of base stations; means for receiving second messages from the plurality of base stations, the second messages comprising transmission power control (TPC) parameters, the TPC parameters being based, at least in part on measurements of received signal power for the first messages obtained at the base stations; and means for determining one or more parameters indicative of a first motion of the mobile device based, at least in part, on the TPC parameters.

It should be understood that the aforementioned implementations are merely example implementations, and that claimed subject matter is not necessarily limited to any particular aspect of these example implementations.

### BRIEF DESCRIPTION OF THE FIGURES

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic diagram of a mobile communication network according to an embodiment;

FIGS. 2A, 2B and 3 are diagrams illustrating motion of a mobile device in a horizontal plane with respect to base stations according to an embodiment;

FIG. 4 is a flow diagram of a process for characterizing motion of a mobile device based, at least in part, on transmission power control (TPC) parameters according to an embodiment; and

FIG. 5 is a schematic block diagram of a mobile device, in accordance with an example implementation.

Reference is made in the following detailed description to accompanying drawings, which form a part hereof, wherein like numerals may designate like parts throughout that are identical, similar and/or analogous. In certain cases, a numeric label for an element may be followed by an alphabetic subscript to indicate a particular instance of the element. In such a case, reference to the numeric label without a subscript may refer to any instance of the element. As an example, there may be specific instances 210ₐ, 210_{b} and 210_{c} of a base station. A reference to a base station 210 may then refer to any of the base stations 210ₐ, 210_{b} and 210_{c}.

It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like mean that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. However, these and other issues have a potential to vary in a particular context of usage. In other words, throughout the disclosure, particular context of description and/or usage provides helpful guidance regarding reasonable inferences to be drawn; however, likewise, “in this context” in general without further qualification refers to the context of the present disclosure.

In some devices or in some scenarios, positioning techniques based on the acquisition of satellite positioning system (SPS) signals and/or the acquisition of certain terrestrial positioning signals (e.g., a PRS) may not be available to a mobile device. According to an embodiment, a mobile device receiving wireless service using Long Term Evolution (LTE) from multiple different eNodeB (eNB) devices (e.g., using uplink carrier aggregation (ULCA), also referred to as LTE carrier aggregation (LTE-CA) or uplink LTE-CA) may be capable of detection of movement (also referred to herein as “motion”) based, at least in part, on transmission power control (TPC) commands decoded from messages received from the different eNodeB devices. TPC commands from an eNodeB device to a mobile device may indicate that the mobile device is to increase or decrease its transmission power on an uplink signal to the eNodeB device. According to an embodiment, TPC commands from an eNodeB device decoded by a mobile device may indicate, for example, whether the mobile device is moving toward or away from (or has moved toward or away from) the eNodeB device. In other embodiments, TPC commands may be received by mobile device 100 from gNB devices in support of carrier aggregation for NR or 5G and may be similarly used to determine movement of mobile device 100.

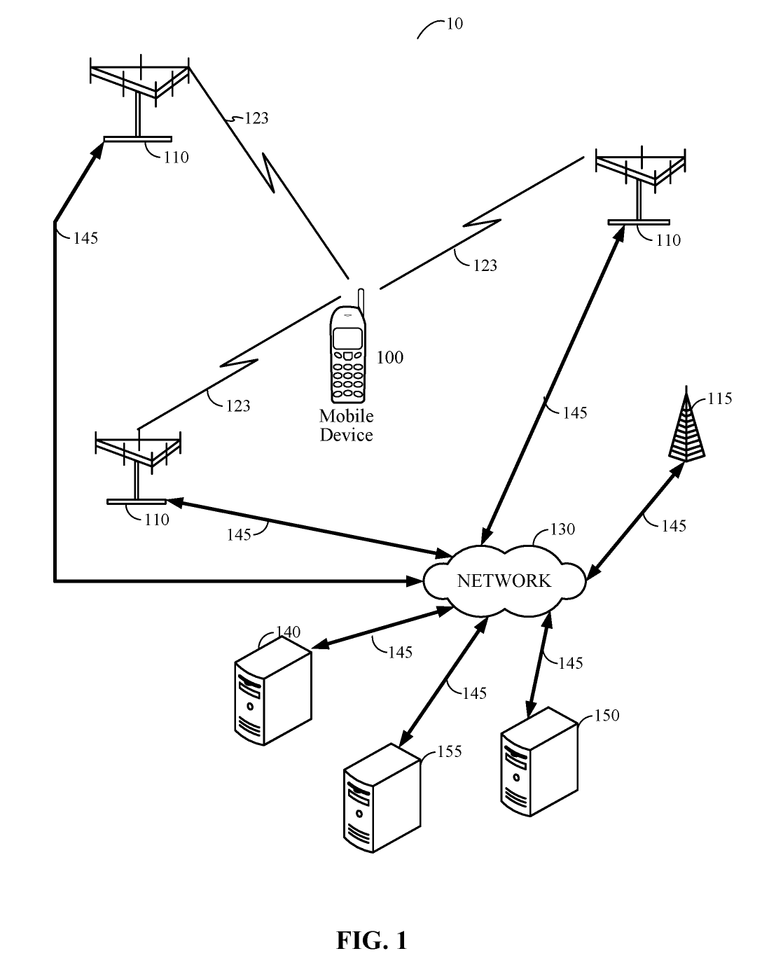

FIG. 1 shows an example communication system 10, in which a mobile device 100, which may also be referred to as a user equipment (UE), transmits radio signals to, and receives radio signals from, a wireless communication network 130 (also referred to herein as network 130). Mobile device 100 may be referred to as a mobile station, wireless device, mobile terminal, wireless terminal and by other names and may correspond to a cellular phone, smartphone, tablet, laptop, PDA, tracking device, navigation device and to other types of device. In one example, mobile device 100 may communicate with wireless communication network 130 by transmitting wireless signals to, and/or receiving wireless signals from, one or more cellular transceivers 110 which may comprise a wireless base transceiver subsystem (BTS), a Node B transceiver, an evolved NodeB (eNodeB) transceiver or an NR NodeB (also referred to as a gNB) over wireless communication links 123. Examples of network technologies that may support wireless communication link 123 are Global System for Mobile Communications (GSM), Code Division Multiple Access (CDMA), Wideband CDMA (WCDMA), Long Term Evolution LTE), High Rate Packet Data (HRPD), New Radio (NR) (also referred to as Fifth Generation (5G)). GSM, WCDMA, LTE and NR are technologies defined by (or being defined by) the Third Generation Partnership Project (3GPP). CDMA and HRPD are technologies defined by the 3rd Generation Partnership Project 2 (3GPP2). WCDMA is also part of the Universal Mobile Telecommunications System (UMTS). Cellular transceivers 110 may comprise deployments of equipment providing subscriber access to wireless telecommunication network 130 for a service (e.g., under a service contract). Here, a cellular transceiver 110 may perform functions of a cellular base station in servicing subscriber devices within a cell determined based, at least in part, on a range at which the cellular transceiver 110 is capable of providing access service. Of course it should be understood that this is merely an example of a network that may facilitate communication with a mobile device over a wireless link, and claimed subject matter is not limited in this respect.

In a particular implementation, cellular transceivers 110 may communicate with servers 140, 150 and/or 155 over network 130 through links 145. Here, network 130 may comprise any combination of wired or wireless links and may include cellular transceivers 110 and/or local transceivers 115 and/or servers 140, 150 and 155. For example, local transceivers 115 may include WiFi access points (APs) supporting IEEE 802.11 wireless access and/or small cells (also referred to as home base stations) supporting cellular communication according to WCDMA, LTE or NR, for example. In a particular implementation, network 130 may comprise Internet Protocol (IP) or other infrastructure capable of facilitating communication between mobile device 100 and servers 140, 150 or 155 through local transceiver 115 or cellular transceiver 110. In another implementation, network 130 may comprise cellular communication network infrastructure such as, for example, a base station controller or packet based or circuit based switching center (not shown) to facilitate mobile cellular communication with mobile device 100. In a particular implementation, network 130 may comprise local area network (LAN) elements such as WiFi APs, routers and bridges and may in that case include or have links to gateway elements that provide access to wide area networks such as the Internet. In other implementations, network 130 may comprise a LAN and may or may not have access to a wide area network but may not provide any such access (if supported) to mobile device 100. In some implementations, network 130 may comprise multiple networks (e.g., one or more wireless networks and/or the Internet).

In one implementation, network 130 may include one or more serving gateways and/or Packet Data Network (PDN) gateways which may support user plane communication with mobile device 100 using IP to enable voice, data and other media communication with mobile device 100. In addition, one or more of servers 140, 150 and 155 may be a location server configured to request and/or coordinate the determination of a location (also referred to as a position) for mobile device 100. Examples of a location server include an Enhanced Serving Mobile Location Center (E-SMLC), a Secure User Plane Location (SUPL) Location Platform (SLP), a SUPL Location Center (SLC), a SUPL Positioning Center (SPC), a Location Management Function (LMF), a Position Determining Entity (PDE) and a gateway mobile location center (GMLC), each of which may connect to one or more entities in network 130 such as a location retrieval function (LRF), a mobility management entity (MME) and/or a PDN Gateway. Other examples of a location server include proprietary servers supported by a network operator or vendor (e.g. a vendor for the mobile device 100 or a vendor for an operating system or modem device of the mobile device 100) which may communicate with mobile device 100 using a user plane (e.g. using IP) to request a location from mobile device 100 or to deliver assistance data to mobile device 100 such as the locations of cellular transceivers 110 and/or local transceivers 115.

In a particular implementation, cellular transceivers 110 may implement ULCA enabling mobile device 100 to concurrently transmit messages on uplink signals to multiple cellular transceivers 110 and/or local transceivers 115. In an embodiment, a cellular transceiver 110 may transmit transmission power control (TPC) commands to mobile device 100 indicating, for example, commands to mobile device 100 for increasing or decreasing transmission power for uplink signals transmitted from mobile device 100 to the cellular transceiver 110. For example, based, at least in part, on a received signal power of an uplink signal transmitted by mobile device 100 as measured at a cellular transceiver 110, the cellular transceiver may formulate one or more TPC commands in a downlink signal to mobile device 100. The one or more TPC commands may request that mobile device 100 increase or decrease transmission power.

Cellular transceiver(s) 110 (and/or local transceiver(s) 115) may transmit TPC commands to mobile device 100 on a continuous or periodic basis, or whenever downlink communication needs to be sent to mobile device 100, or whenever uplink communication from mobile device 100 is acknowledged, and/or at other times. Further, more than one cellular transceiver 110 and/or local transceiver 115 may transmit TPC commands to mobile device 100 at the same time or almost the same time when mobile device 100 is sending data, voice, signaling or other uplink communication to network 130—e.g. to support LTE Advanced (LTE-A) wireless access with carrier aggregation. A TPC command transmitted to mobile device 100 by a cellular transceiver 110 and/or local transceiver 115 may indicate to mobile device 100 that a transmission power for an uplink signal from mobile device 100 should be increased, decreased or remain the same.

If transmission power of an uplink signal from mobile device 100 to a cellular transceiver 110 remains constant, a received signal power of the uplink signal as measured at a cellular transceiver 110 may increase as mobile device 100 moves toward the cellular transceiver 110, shortening a distance between the cellular transceiver 110 and mobile device 100. Here, as the distance between the cellular transceiver 110 and mobile device 100 decreases and received power as measured at the cellular transceiver 110 increases, the cellular transceiver 110 may provide one or more TPC commands to mobile device 100 requesting a decrease in transmission power for the uplink signal transmitted to the cellular transceiver 110. Accordingly, if mobile device 100 receives one or more TPC commands from a cellular transceiver 110 requesting a decrease in transmission power, it may be inferred that mobile device 100 may be moving toward the cellular transceiver 110.

Conversely, if the transmission power of an uplink signal from mobile device 100 to a cellular transceiver 110 remains constant, a received signal power of the uplink signal as measured at the cellular transceiver 110 may decrease as mobile device 100 moves away from the cellular transceiver 110, increasing a distance between the cellular transceiver 110 and mobile device 100. Here, as the distance between the cellular transceiver 110 and mobile device 100 increases and received power as measured at the cellular transceiver 110 decreases, the cellular transceiver 110 may provide one or more TPC commands to mobile device 100 requesting an increase in transmission power for the uplink signal transmitted to the cellular transceiver 110. Accordingly, if mobile device 100 receives one or more TPC commands from a cellular transceiver 110 requesting an increase in transmission power, it may be inferred that mobile device 100 may be moving away from (or has moved away from) the cellular transceiver 110.

In addition, if the transmission power of an uplink signal from mobile device 100 to a cellular transceiver 110 remains constant, a received signal power of the uplink signal as measured at the cellular transceiver 110 may remain constant (or almost constant) while mobile device 100 remains at the same or about the same distance from the cellular transceiver 110. Here, the cellular transceiver 110 may provide one or more TPC commands to mobile device 100 requesting no change in the transmission power for the uplink signal transmitted to the cellular transceiver 110. Accordingly, if mobile device 100 receives one or more TPC commands from a cellular transceiver 110 requesting no change in transmission power, it may be inferred that mobile device 100 is maintaining a constant distance from the cellular transceiver 110. This may not, however, mean that mobile device 100 is stationary. For example, mobile device 100 could be stationary or mobile device 100 could be moving but at a constant distance from the cellular transceiver 110 (e.g. moving along an arc of a circle centered at the cellular transceiver 110).

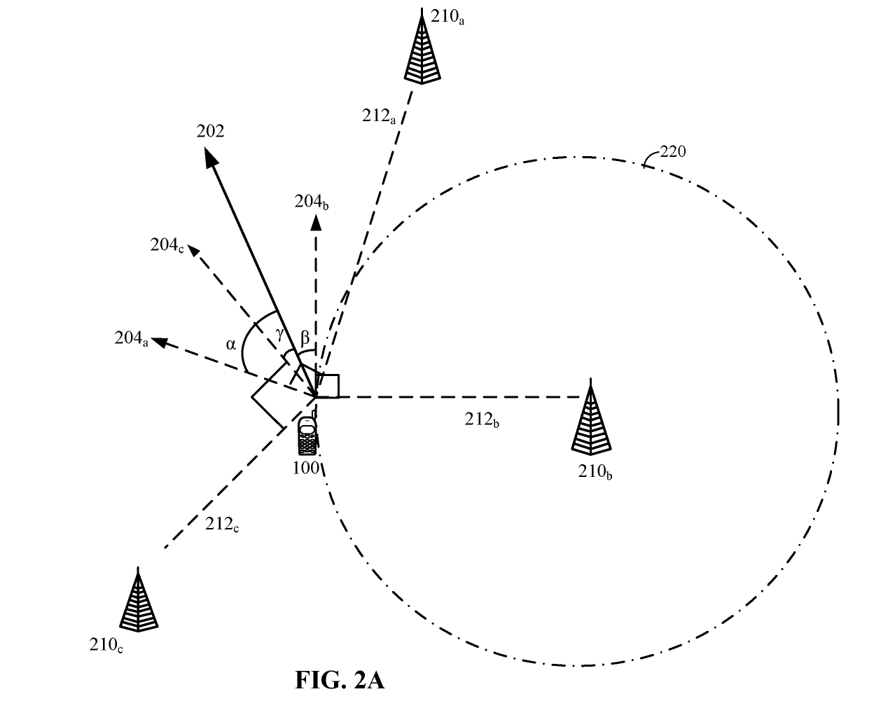

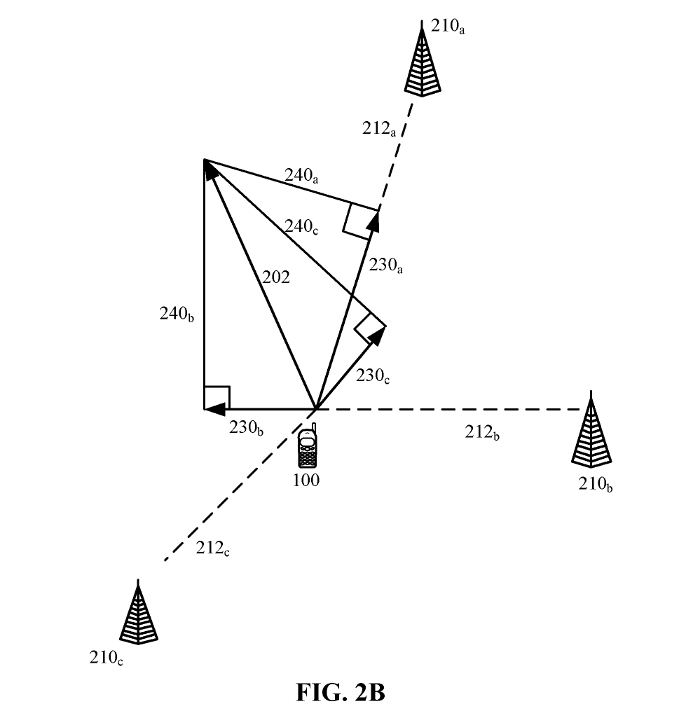

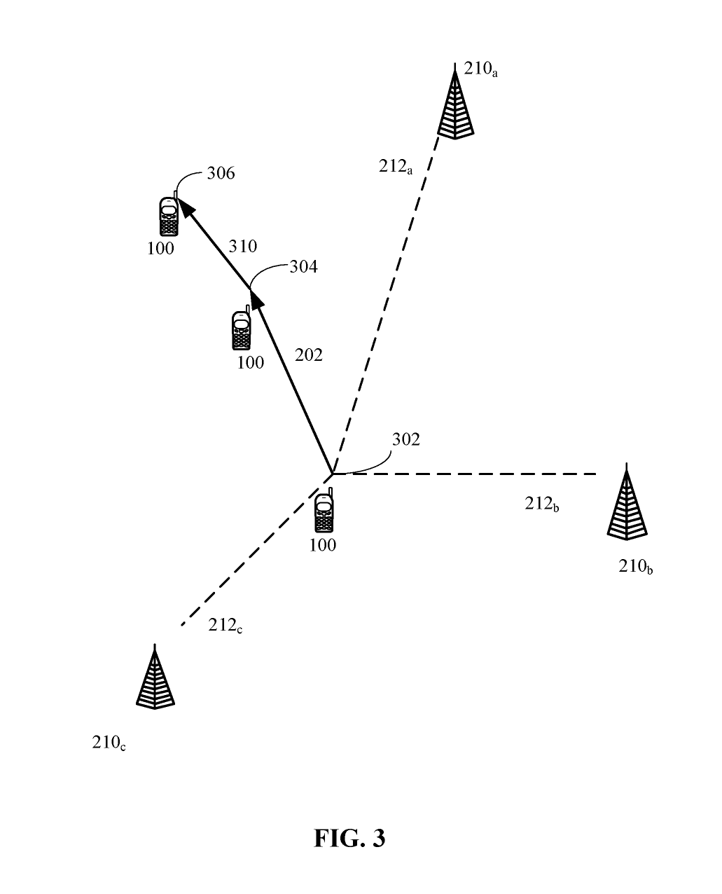

According to an embodiment, based, at least in part, on TPC commands received from three or more cellular transceivers 110 (and/or local transceivers 115) requesting an increase or decrease in transmission power for three or more concurrent uplink signals to the three or more cellular transceivers 110, a motion of mobile device 100 in a particular path may be inferred or characterized. FIGS. 2A, 2B and FIG. 3 are planar views illustrating motion of mobile device 100 in a horizontal plane with respect to base stations 210 according to an embodiment. As shown in FIG. 2A, mobile device 100 may move along a path in a direction 202 with respect to base stations 210 which are stationary. Base stations 210 may correspond to cellular transceivers 110 and/or to local transceivers 115 in communication system 10. Messages containing TPC commands from each base station 210 may indicate whether mobile device 100 is moving toward or away from (or has moved toward or away from) or is remaining at a constant distance from the base station 210 as discussed above. In the example shown in FIG. 2A, a TPC command from base station 210ₐ transmitted to mobile device 100 may request a decrease in uplink transmission power, which may indicate that mobile device 100 is moving toward base station 210ₐ along line of sight (LOS) path 212ₐ (also referred to later herein as radius 212ₐ or as line 212ₐ). Similarly, a TPC command from base station 210_{b} transmitted to mobile device 100 may request an increase in uplink transmission power, which may indicate that mobile device 100 is moving away from (or has moved away from) base station 210_{b} along LOS path 212_{b}. Further, a TPC command from base station 210_{c} transmitted to mobile device 100 may request an increase in uplink transmission power, which may indicate that mobile device 100 is moving away from (or has moved away from) base station 210_{c} along LOS path 212_{c}. Receiving TPC commands contemporaneously from base stations 210ₐ, 210_{b} and 210_{c}, mobile device 100 may infer aspects of direction 202 and distance travelled in direction 202 representing movement of mobile device 100. Accordingly, mobile device 100 may infer a vector 202 comprising both the direction 202 and a distance moved in the direction 202. In the description that follows, a direction, a distance and a vector that characterize the same movement of the mobile device in a particular direction are indicated using the same numeric label, for convenience.

To illustrate a technique, referred to herein as technique T1, concerning usage of TPC commands to infer direction and distance of movement, a circle 220 is shown in FIG. 2A having a center as a location of base station 210_{b} and having a radius 212_{b} equaling a distance between base station 210_{b} and a current location for mobile device 100 (and thus which passes through the current location for mobile device 100). If mobile device 100 moves along the circle 220, the distance to base station 210_{b} may remain constant and TPC commands from base station 210_{b} may generally indicate a request to keep transmission power constant. Conversely, if mobile device 100 moves to a location inside circle 220, a distance to base station 220_{b} may decrease and TPC commands from base station 220_{b} may generally request a reduction in transmission power. Alternatively, if mobile station 100 moves to a location outside circle 220, a distance to base station 220_{b} may increase and TPC commands from base station 220_{b} may generally request an increase in transmission power. Over a short time interval (e.g., 15 seconds or less), a distance travelled by mobile device 100 may be small compared to the radius 212_{b} of the circle 220 and mobile device 100 may move in a roughly constant direction (e.g., because of insufficient time to significantly change direction). In this case, over a short time period, maintaining a constant distance to base station 210_{b} by mobile device 100 may correspond to movement (in either direction) along the tangent 204_{b} (shown with a clockwise direction in FIG. 2A) to the circle 220 at the current location of mobile device 100. Similarly, increasing the distance to base station 210_{b} by mobile device 100 may correspond to moving in a direction 202 away from the circle 220, where the anticlockwise angle β shown in FIG. 2A between tangent 204_{b} and the direction 202 satisfies 0<β<180 degrees. In this context, the term “clockwise angle” and “anticlockwise angle” between a vector or direction A and another vector or direction B, as used herein, refers to the direction and angle of rotation when A is rotated to align with B. Further, decreasing the distance to base station 210_{b} by mobile device 100 may correspond to moving in a direction 202 towards the circle 220, where the anticlockwise angle β shown in FIG. 2A between the tangent 204_{b} and the direction 202 satisfies 180<β<360 degrees. It is noted that while FIG. 2A shows the direction 202 as being away from the circle 220, increasing the angle β to exceed 180 degrees would rotate the direction 202 towards the circle 220 (though this is not explicitly shown in FIG. 2A). It is also noted that for a clockwise angle β in FIG. 2A or an oppositely pointing (anticlockwise) tangent 204_{b}, the previous conditions 0<β<180 degrees and 180<β<360 degrees may be reversed.

TPC commands from any of the base stations 204ₐ, 204_{b} and 204_{c} in FIG. 2A may thus be used, in technique T1, to determine whether the mobile device 100 is moving along a tangent to a circle centered at that base station that passes through a current location for the mobile device 100 or is moving away from or towards this circle. For simplicity, circles around base stations 210ₐ and 210_{c} are not shown in FIG. 2A. However, the tangents to these circles are shown in FIG. 2A and are shown as being at right angles to the radius of each circle connecting each base station to the current location for the mobile device 100. Thus, tangent 204ₐ in FIG. 2A is a tangent (shown with a clockwise direction in FIG. 2A) to a circle (not shown in FIG. 2A) centered on base station 210ₐ and passing through the current location of mobile device 100 and at right angles to the radius 212ₐ. Similarly, tangent 204_{c} in FIG. 2A is a tangent (shown with an anticlockwise direction in FIG. 2A) to a circle (not shown in FIG. 2A) centered on base station 210_{c} and passing through the current location of mobile device 100 and at right angles to the radius 212_{c}. FIG. 2A shows the clockwise angle α between the tangent 204ₐ and the direction of movement 202 of mobile device 100, and the clockwise angle γ between the tangent 204 and the direction of movement 202 of mobile device 100. In the example in FIG. 2A, and as described previously, the TPC commands sent by the base stations 201ₐ, 210_{b} and 210_{c} to the mobile device 100 indicate that the transmission power of the mobile device 100 should, respectively, decrease, increase and increase. Based on the previous example for the case of the tangent 204_{b} to the circle 220 centered on base station 210_{b} and allowing for the clockwise versus anticlockwise definitions of these angles and the clockwise versus anticlockwise directions of the tangents as mentioned above, this means that the angles α, β and γ should satisfy:

0<α<180 degrees (1)

0<β<180 degrees (2)

0<γ<180 degrees (3)

In order to satisfy inequalities (1), (2) and (3) according to technique T1, the direction 202 in FIG. 2A must lie in between the directions of the two tangents 204_{b} and 204_{c}, as shown in FIG. 2A. In the example in FIG. 2A, this equates to a direction with approximately 45 degrees of uncertainty (corresponding to the angle between the tangents 204_{b} and 204_{c} which is shown in FIG. 2A as being approximately 45 degrees).

To further improve the accuracy of the direction 202, a technique T2 may be used wherein the frequency of TPC commands requesting an increase, decrease or no change in the transmission power of the mobile device 100 may also be compared. For example, over a short period (e.g. 15 seconds to a few minutes), a mobile device 100 may determine a parameter for each base station 210 comprising the number of requests to increase transmission power minus the number of requests to reduce transmission power. As long as TPC commands are received at the same or almost the frequency from each base station 210, the parameter for each base station 210 may be related to (e.g. may have an absolute value approximately proportional to) the change in distance between the mobile device 100 and the base station 210 with a positive value for the parameter indicating movement away from the base station 210 and a negative value indicating movement towards the base station 210. In the case of the example in FIG. 2A, this may be used to help determine the direction 202 more precisely between the two tangents 204_{b} and 204_{c}.

FIG. 2B shows an example of the technique T2 applied to the mobile device 100 and base stations 210 in FIG. 2A. In FIG. 2B, it is assumed that mobile device 100 uses the frequencies of TPC commands received from each of the base stations 210 to determine a vector 230 of movement towards or away from each base station 210 along the straight line (or radius) 212 between the mobile device 100 and the base station 210 as previously described. The vectors 230 in FIG. 3 may have known lengths (e.g. where mobile device 100 is able to determine the exact distance moved towards or away from each base station 210) or may have known relative lengths (e.g. where exact distances moved are not known but where the distances moved towards or away from each base station 210 have known ratios to one another). The mobile device 100 may then determine the vector 202 whose projections 240 onto each of the vectors 230 (where a projection 240 is at right angles to a corresponding vector 230) exactly fits the known length or known relative length of each vector 230 as shown in FIG. 2B. This vector 202 may represent the direction and distance or relative distance of movement of the mobile device 100.

In the event of errors in determining the vectors 230 in FIG. 2B, it is possible that no single vector 202 can be determined by the mobile device 100 with the projections 240 just described. In this case, the mobile device 100 may determine a vector 202 with projections 240 onto the lines 212 that define other vectors 230* whose lengths may be different, or at least slightly different, to the corresponding vectors 230 determined from the TPC commands. For each base station 210, the mobile device 100 may determine an error vector 230# given by the vector 230 for that base station 210 minus the vector 230* for that base station 210 using vector subtraction. The error vectors 230# for the base stations 210 (e.g. base stations 210ₐ, 210_{b} and 210_{c} in FIG. 2B) may then be summed using vector addition. The mobile device 100 may then determine the vector 202 for which this vector sum has the minimum scalar magnitude which may be used as the resulting direction of movement for the mobile device 100 and the resulting distance or relative distance of movement. Other methods of determining the vector 202 in the presence of errors in the vectors 230 are also possible.

A mobile device 100 may also or instead use a technique T3, whereby the transmission power to each base station 210 is compared at the start of and end of a certain period (e.g. lasting 15 seconds to a few minutes). If it is assumed that the signal strength received from mobile device 100 by each base station 210 is kept approximately constant by that base station using TPC commands, then the starting and ending transmission power may be used to determine the change in distance to the base station 210 using known relationships between signal propagation distance and signal strength. For example, the transmission power of mobile device 100 towards some base station 210 at the end of the period may be based on the transmission power towards the base station 210 at the start of the period and the TPC commands received by the mobile device 100 from the base station 210 during the period which change the transmission power during the period. The change in distance between the mobile station 100 and each base station 210 may be used to determine the vectors 230 in FIG. 2B from which the vector 202 defining the overall movement of the mobile device 100 may be determined as previously described for FIG. 2B. A mobile device 100 may further use two or more of techniques T1, T2 and T3 to determine the direction of movement 202 and/or the distance 202 moved by the mobile device 100, thereby helping to determine the vector 202. The determined vector 202 may be used to compute a location for mobile device 100 if an initial location for mobile device 100 is already known (e.g. using other measurements such as PRS or SPS measurements), by simply combining the vector 202 with the initial location.

The techniques T1, T2 and T3 described previously in relation to FIGS. 2A and 2B assume that mobile device 100 has knowledge of the directions and possibly distances to the base stations 210ₐ, 210_{b} and 210_{c}. For example, all three techniques may require knowledge by mobile device 100 of the directions of base stations 210ₐ, 201_{b} and 210_{c} along the lines 212ₐ, 212_{b} and 212_{c}, respectively, from the current location of mobile device 100. Further, techniques T2 and/or T3 may require knowledge by mobile device 100 of the distances to base stations 210ₐ, 210_{b} and 210_{c} along the lines 212ₐ, 212_{b} and 212_{c}, respectively, from the current location of mobile device 100. This knowledge may be obtained in different ways. For example, one or more of base stations 210ₐ, 210_{b} and 210_{c} may broadcast the absolute location of itself and possibly the absolute locations of one or more others of base stations 210ₐ, 210_{b} and 210_{c}. In addition or alternatively, a location server 140, 150 or 155 may provide mobile device 100 with messages indicating one or more of the absolute locations. Mobile device 100 may then determine the directions and/or distances based on a known initial location for mobile device 100 (e.g. if mobile device is able, at least occasionally, to determine its location by methods not dependent on TPC commands). Mobile device 100 may also determine an approximate distance to any base station 210 if a timing advance (TA) is provided to mobile device 100 by the base station 210 in a downlink signal or message, since a TA is typically approximately equal to a round trip signal propagation time (RTT) between mobile device 100 and the base station 210 in order to synchronize uplink transmission from mobile device 100 to downlink transmission from the base station 210 from the perspective of the base station 210. Using the TA to approximate an RTT enables the distance to be obtained as RTT*c/2 where c is the signal speed (e.g. velocity of light). The mobile device 100 may also determine a direction to a base station 210 by measurement of a downlink signal angle of arrival (AOA) or from knowledge of an angle of departure (AOD)—e.g. if the base station 210 indicates an AOD.

According to an embodiment, and as an exemplified in FIG. 2A, magnitudes and/or frequencies of requested increases or decreases in transmission power in TPC commands from base stations 210ₐ, 210_{b} and 210_{c} may be used to compute an estimated or approximate direction and magnitude of movement for mobile device 100. In the particular illustrated example of FIG. 2A, TPC commands from base station 210ₐ requesting a decrease in transmission power in an uplink signal to base station 210ₐ (e.g., indicating that mobile device 100 is moving toward base station 210ₐ), TPC commands from base station 210_{b} requesting an increase in transmission power (e.g., indicating that mobile device 100 is moving away from base station 210_{b}) and TPC commands from base station 210_{c} requesting an increase in transmission power (e.g., indicating that mobile device 100 is moving away from base station 210) may indicate that mobile device 100 is in motion along vector 202. It should be understood that this is merely one particular example of how TPC commands from three or more base stations may be used to estimate or approximate a direction and magnitude of movement of a mobile device 100, and claimed subject matter is not limited in this respect.

As illustrated in FIG. 3, movement of mobile device 100 relative to base stations 210ₐ, 210_{b} and 210_{c} may be tracked over time. For example, initial TPC commands received by mobile device 100 during a first period (e.g. while mobile device 100 is moving from location 302 to location 304) requesting an increase or decrease in transmission power for uplink signals to base stations 210ₐ, 210_{b} and 210_{c} may indicate movement of mobile device 100 from location 302 to location 304 according to vector 202. Subsequent TPC commands received by mobile device 100 during a second period (e.g. while mobile device 100 is moving from location 304 to location 306) requesting an increase or decrease in transmission power for uplink signals to base stations 210ₐ, 210_{b} and 210_{c} may indicate movement of mobile device 100 from location 304 to location 306 along vector 310. Each of the vectors 202 and 310 may be determined by mobile device 100 using one or more of the techniques described in relation to FIGS. 2A and 2B. Mobile device 100 may combine the vectors 202 and 310 to determine the change in location from location 302 to location 306. While the change in location may be relative to location 302, mobile device 100 may be able to determine an absolute location 302 (e.g. that may include or comprise a latitude and longitude) if an absolute location (e.g. latitude and longitude) is previously known for location 302. Mobile device may 100 may determine locations for mobile device 100 subsequent to location 306 in a similar manner by determining vectors for mobile device 100 based on the techniques described in relation to FIGS. 2A and 2B and combining these separate vectors. Moreover, mobile device 100 may use TPC commands received from other base stations 210 to determine vectors if mobile device 100 receives TPC commands from other base stations 210 not shown in FIGS. 2A and 2B and/or undergoes handover or cell change between different base stations 210. Mobile device 100 may use determined vectors (e.g. vector 202 or vector 310) to determine a velocity for mobile device 100—e.g. by dividing the scalar magnitude of a vector by the time taken to move along the vector.

According to an embodiment, TPC commands may be used to supplement or replace measurements from inertial navigation sensors attached to or accessible from mobile device 100, such as measurements from accelerometer(s), gyroscope(s) and/or magnetometer(s). In the example of FIG. 3, TPC commands may be received at mobile device 100 prior to and/or when located at position 304. However, instead of using the received TPC commands to determine a movement of mobile device 100 from position 302 to position 304, mobile device 100 may determine parameters indicative of the movement of mobile device 100 to position 304 along vector 202 (e.g. such as a direction and distance of the movement) based, at least in part, on measurements from the inertial navigation sensors. A location of, distance to and/or direction to one or more of base stations 210ₐ, 210_{b} and/or 210_{c} may then be determined based, at least in part, on the parameters indicative of the movement from position 302 to position 304 determined from the measurements obtained from the inertial navigation sensors and other parameters indicative of this same movement obtained from the TPC commands. For example, referring to the example in FIGS. 2A and 3, technique T1 shows how inequalities (1), (2) and (3) may be used to determine the angles α, β and γ between the tangents 204ₐ, 204_{b} and 204_{c}, respectively, and the vector 202 along which mobile device 100 moves from position 302 to position 304. If the direction of the vector 202 is already known from inertial sensor measurements, the angles α, β and γ may be used to determine the directions of the tangents 204ₐ, 204_{b} and 204_{c}, respectively, and from these the directions of the radii 212ₐ, 212_{b} and 212_{c}, respectively, connecting position 302 to the base stations 210ₐ, 210_{b} and 210_{c}, respectively. Although inequalities (1) to (3) do not provide precise values for the angles α, β and γ and thus do not provide precise directions to the base stations 210ₐ, 210_{b} and 201_{c}, more precise values and directions may be possible if mobile device 100 moves along a path that includes a number of different directions. For example, mobile device 100 may determine the path from the inertial sensor measurements and may segment the path into a number of approximate straight line segments with the inertial navigation sensors used to determine the direction and length of each straight line segment. Inequalities (1) to (3) may then be used to determine directions to the base stations 210ₐ, 210_{b} and 210_{c} relative to each straight line segment based on TPC commands received by mobile device 100 while moving along each straight line segment. The directions to any base station 210 from all the straight line segments may then be combined—e.g. by determining a single direction or a small set of directions that are consistent with the directions to this base station 210 relative to each of the straight line segments.

Such reverse positioning of the base stations 210 may also be applied to techniques T2 and T3 for FIGS. 2A and 2B where a known movement of the mobile device 100 determined from measurements obtained from inertial sensors is used to determine a distance and/or a direction to one or more of the base stations 210. In the case of technique T2, distances or relative distances moved towards or away from each of the base stations 210 may be determined based on the frequency of received TPC commands. In the case of technique T3, the absolute distances moved towards or away from each of the base stations 210 may be determined based on the received TPC commands. However, instead of using the relative or absolute distances to position mobile device 100, the distances may be used to help position the base stations 210.

For example, an embodiment employing technique T2 and/or T3 may be used to determine an absolute distance moved by the mobile device 100 toward or away from each base station 210, and vector 202 in FIG. 2B defining the movement of the mobile device 100 may also be determined from the inertial sensor measurements. Here, mobile device 100 may then determine a vector 230, as shown in FIG. 2B, whose scalar magnitude equals the distance moved towards or away from the base station 210 and whose direction is such that the projection 240 of the vector 202 onto the vector 230 exactly fits the length of the vector 230. In general, there may be two such vectors 230 with this property, one on either side of the vector 202 (not shown in FIG. 2B). The two vectors 230 may provide alternative directions to the base station 210 from the current location of the mobile device 100. An ambiguity of these alternatives may be resolved if the mobile device 100 repeats the above procedure for further movement of the mobile device 100 in other directions whereby other vectors 230 are determined for each base station 210. Vectors 230 that are not consistently determined for a particular base station 210 with the same direction may be ignored by mobile device 100 whereas vectors 230 with a consistent direction may be assumed by mobile device 100 to provide the correct direction to the base station 210. An absolute distance to each base station 210 may also be determined using a TA value or RTT measurement (e.g. obtained by mobile device 100 or provided to mobile device 100 by the base station 210) from which the location of the base station 210 relative to the mobile device 100 can be determined.

The mobile device 100 may use the determined directions to, distances to and/or locations of the base stations 210 to determine a movement or location of the mobile device 100 at a later time. For example, a location determined using measurements from inertial sensors may degrade and become less accurate over a period of time (e.g., more than 10 minutes) due to the accumulation of measurement errors. However, if mobile device 100 has determined the locations of base stations 210 as just described based on TPC commands and measurements from the inertial sensors at an earlier time, or has been provided with the locations of base stations 210 (e.g. by one or more of the base statins 210 or by a location server 140, 150 or 155), mobile device 100 may use these locations to determine a change in location for mobile device 100 and/or an absolute location for mobile device 100 using TPC commands as described for FIGS. 2A, 2B and 3. Following any determination of an absolute location for mobile device 100 based on TPC commands, measurements from inertial sensors may once again be used by mobile device, alone or in combination with TPC commands, to track the movement of mobile device 100.

In another embodiment, TPC commands decoded from messages received by mobile device 100 from three or more base stations 210 may be used to update a predetermined travel path for an autonomous vehicle, for which mobile device 100 is a part, such as a drone. In some implementations, an autonomous vehicle such as a drone may be remotely controlled according to a predetermined travel path (e.g., flight path). In some scenarios, there may be a desire to change a predetermined travel path because of circumstances such as a change in weather conditions or disruption/failure in a communication link with a remote controller providing commands to navigate the autonomous vehicle in the predetermined travel path. According to an embodiment, an autonomous vehicle may comprise an LTE transceiver device (e.g., for receiving navigation commands from a remote controller). Here, the LTE transceiver, which may correspond to mobile device 100 in FIGS. 1-3, may be used for decoding TPC commands in messages received from multiple base stations (e.g. corresponding to cellular transceivers 110 in communication system 10) to infer movement of the autonomous vehicle toward or away base stations positioned at known locations (e.g., as described above with reference to FIGS. 2A, 2B and 3). The autonomous vehicle may store positions/coordinates for different base stations in a look up table. This may enable updating a travel path.

In another embodiment, a mobile device 100 may be capable of obtaining an approximate location of the mobile device 100 by using an enhanced cell-ID (E-CID) technique based on a known location of a serving base station (e.g. an eNB or gNB) and one or more measurements indicative of a range between the mobile device 100 and the base station (e.g., a measurement of received signal strength or RSSI or a measurement of a TA). For example, an E-CID technique may provide a locus of possible locations of the mobile device 100 as a circle centered at the base station and having a radius equal to the range to the base station (e.g. determined from RSSI measurements or a TA). In one particular implementation, such a locus of possible locations of the mobile device 100 obtained using an E-CID technique may be adjusted or enhanced based on an indication of movement of the mobile device 100 toward or away from a base station (e.g., the serving base station for deriving an E-CID position or another base station) based on TPC commands as described above. For example, a range for a locus of possible locations based on E-CID measurements may be adjusted based on TPC commands.

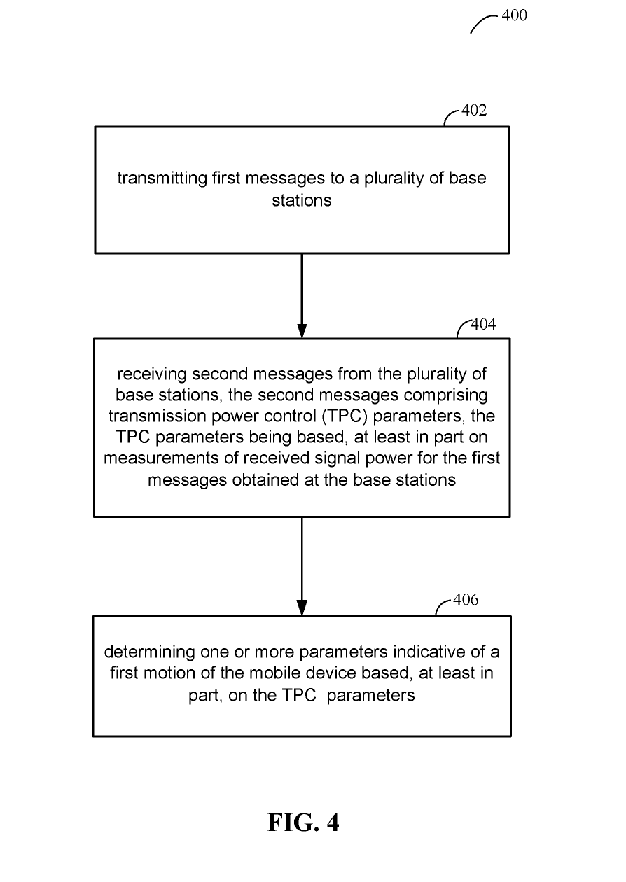

FIG. 4 is a flow diagram of a process 400 for characterizing motion of a mobile device based, at least in part, on TPC parameters. Actions at blocks 402, 404 and 406 may be performed by a mobile device such as mobile device 100. Block 402 may comprise transmitting one or more first messages to a plurality of base stations. The plurality of base stations may correspond to base stations 210, cellular transceivers 110 and/or local transceivers 115 and/or may comprise a plurality of eNodeB transceiver devices for LTE-CA or a plurality of NR NodeB (gNB) transceiver devices for NR Carrier Aggregation. For example, block 402 may comprise mobile device 100 transmitting any one of several cellular service messages or signals in uplink (or shared) communication channels to cellular transceivers 110 (e.g., according to an implementation of ULCA). As pointed out above, a base station receiving a message or signal transmitted at block 402 may measure a received signal strength indication (RSSI) or received signal power of the first messages or signals, and transmit a TPC command to the mobile device requesting that the mobile device increase transmission power, decrease transmission power or not change transmission power on an uplink communication channel to the base station. The messages or signals transmitted by the mobile device to each base station may be different and may be transmitted with a distinct transmission power that may be different for each base station.

Block 404 may comprise receiving second messages (or second signals) from the plurality of base stations, where the second messages (or second signals) comprise transmission power control (TPC) parameters, where the TPC parameters are based, at least in part on measurements of received signal power for the first messages obtained at the base stations. In this context, “TPC parameters” as referred to herein, comprise one or more symbols, values or parameters to affect transmission power at the mobile device. In one implementation, TPC parameters sent by a particular base station in the plurality of base stations may comprise bits or other values in a field of one more of the second messages requesting an increase, a decrease or no change in transmission power of the mobile device towards this base station. It should be understood, however, that this is merely an example of TPC parameters, and that claimed subject matter is not limited in this respect.

Block 406 may comprise determining one or more parameters indicative of a first motion of the mobile device based, at least in part, on the TPC parameters in messages received at block 406. Parameters indicative of the first motion of the mobile device may include one or more parameters indicative of a change in location, a speed or velocity of the mobile device, a straight line distance, a direction, a movement toward one of the plurality of base stations, a movement away from one of the plurality of base stations, a movement at a constant distance from one of the plurality of base stations, or some combination of these. In an example, parameters indicative of the first motion of the mobile device may indicate a magnitude and direction of change in location and/or velocity. It should be understood, however, that these are merely examples of parameters indicative of a motion of the mobile device, and claimed subject matter is not limited in this respect.

In one example implementation, block 406 may determine one or more parameters indicative of the first motion of the mobile device by evaluating an extent to which the mobile device is moving toward, away from or remaining at a constant distance from (or has moved toward, away from or at a constant distance from) particular base stations at known locations or in known directions as discussed above in connection with FIGS. 2A, 2B and 3. In the particular example shown in FIG. 3, mobile device 100 located at position 302 at an initial instance may receive TPC commands from base stations 210ₐ, 210_{b} and 210_{c} at or prior to a subsequent instance when mobile device 100 is located at position 304. As pointed out above, a distance and direction traveled between location 302 and location 304 along vector 202 may be computed, measured, estimated or assessed based, at least in part on the TPC commands received while mobile device 100 is moving towards, and/or is located at, location 304. Furthermore, a speed of mobile device 100 may be computed, measured, estimated or assessed based, at least in part, on the computed, measured, estimated or assessed distance (based, at least in part, on TPC commands received while mobile device 100 is moving towards and/or is located at position 304 at the subsequent instance) divided by a difference between the initial and subsequent instances according to equation (4) as follows:

vₑₛₜ(t₁)=[x(t₁)−x(t₀)]/(t₁−t₀), (4)

where:

t₀ is a time at an initial instance (e.g., when mobile device 100 is located at position 302);

t₁ is a time at a subsequent instance (e.g., when mobile device 100 is located at position 304);

vₑₛₜ(t₁) is an estimated velocity of mobile device 100 in a direction along an x-axis at a subsequent instance at time t₁; and

x(t₁)−x(t₀) is a measured, computed or estimated difference in locations at the initial instance t₀ and the subsequent instance t₁ along an x-axis based on TPC commands received between the initial instance t₀ and the subsequent instance t₁.

According to an embodiment, the difference x(t₁)−x(t₀) in equation (4) may be computed based on a difference in Cartesian coordinates along an x-axis in a horizontal plane, and may be further expressed as having a magnitude and direction. Equation (4) may be similarly applied to determine a velocity for the mobile device along a horizontal y-axis at right angles to the x-axis by substituting values of y for values of x in equation (4) which may enable determination of an overall velocity and direction for the mobile device in a horizontal plane.

According to an embodiment of the process 400, the mobile device performing process 400 may comprise one or more inertial navigation sensors such as accelerometer(s), gyroscopes and/or magnetometers and may determine one or more parameters (e.g. a direction and/or a distance) indicative of a second motion of the mobile device based on the inertial navigation sensors. For example, the second motion may correspond to the vector 202 in the examples described for FIGS. 2A, 2B and 3. The mobile device may then determine one or more parameters indicative of a location of at least one of the plurality of base stations based, at least in part, on the one or more parameters indicative of the first motion and the one or more parameters indicative of the second motion (e.g. as described previously in association with FIGS. 2A, 2B and 3). In this embodiment, the one or more parameters indicative of the location of the at least one of the plurality of base stations may comprise a direction, a distance, a relative location or an absolute location, or a combination of these.

According to this embodiment of the process 400, the mobile device may further determine one or more parameters indicative of a third motion of the mobile device (e.g. a direction and/or a distance) based, at least in part, on the location of the at least one of the plurality of base stations and the TPC parameters. For example, the third motion may correspond to the vector 310 in FIG. 3.

In another embodiment of the process 400, the mobile device may comprise an autonomous vehicle and may determine that a predetermined travel path for the autonomous vehicle is to change in response to a condition or event. The mobile device may then characterize movement of the autonomous vehicle toward or away from one or more of the base stations based on the TPC parameters; and may update the predetermined travel path based, at least in part, on the characterized movement of the autonomous vehicle, as described previously.

In another embodiment of the process 400, the mobile device may determine a location of the mobile device based, at least in part, on the one or more parameters indicative of the first motion.

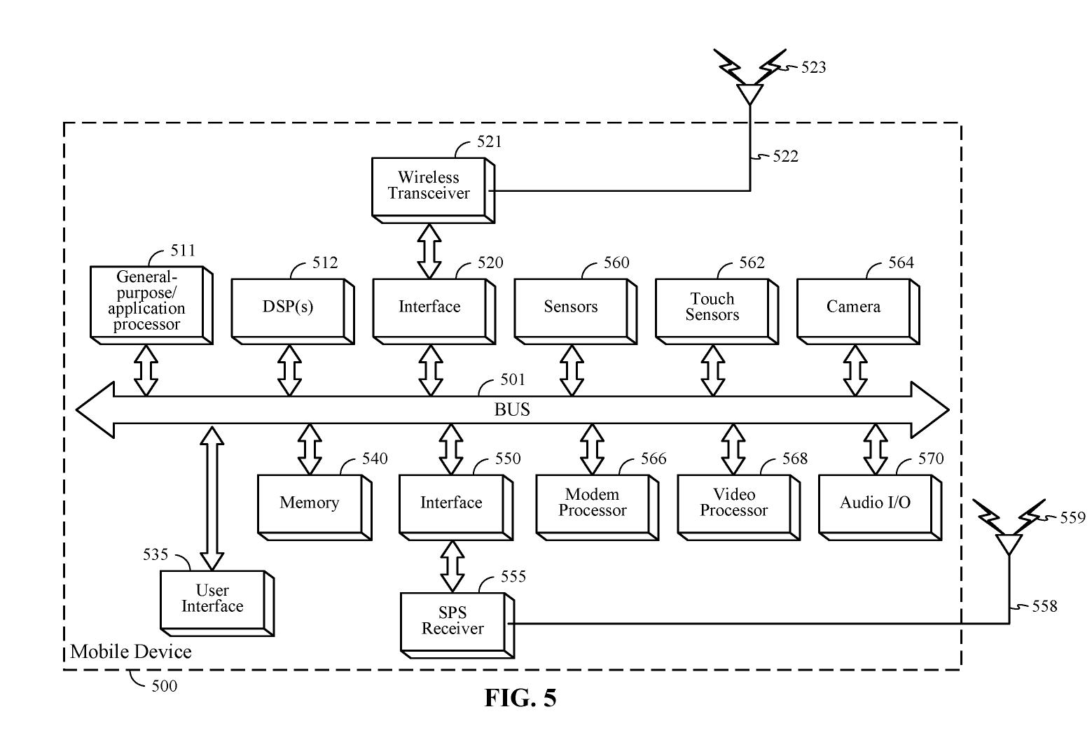

Subject matter shown in FIG. 5 may comprise features, for example, of a computing device, in an embodiment. It is further noted that the term computing device, in general, refers at least to one or more processors and a memory connected by a communication bus. Likewise, in the context of the present disclosure at least, this is understood to refer to sufficient structure within the meaning of 35 USC § 112(f) so that it is specifically intended that 35 USC § 112(f) not be implicated by use of the term “computing device,” “wireless station,” “wireless transceiver device,” “mobile device” and/or similar terms; however, if it is determined, for some reason not immediately apparent, that the foregoing understanding cannot stand and that 35 USC § 112(f) therefore, necessarily is implicated by the use of the term “computing device,” “wireless station,” “wireless transceiver device,” “mobile device” and/or similar terms, then, it is intended, pursuant to that statutory section, that corresponding structure, material and/or acts for performing one or more functions be understood and be interpreted to be described at least in FIG. 4 and corresponding text of the present disclosure.

FIG. 5 is a schematic diagram of a mobile device 500 according to an embodiment. Mobile device 100 shown in FIGS. 1-3 may comprise one or more features of mobile device 500 shown in FIG. 5. In certain embodiments, mobile device 500 may comprise a wireless transceiver 521 which is capable of transmitting and receiving wireless signals 523 via wireless antenna 522 over a wireless communication network (e.g. network 130 in FIG. 1). Wireless transceiver 521 may be connected to bus 501 by a wireless transceiver bus interface 520. Wireless transceiver bus interface 520 may, in some embodiments be at least partially integrated with wireless transceiver 521. Some embodiments may include multiple wireless transceivers 521 and wireless antennas 522 to enable transmitting and/or receiving signals according to corresponding multiple wireless communication standards such as, for example, versions of IEEE Standard 802.11, CDMA, WCDMA, LTE, UMTS, GSM, AMPS, Zigbee, Bluetooth and a 5G or NR radio interface defined by 3GPP, just to name a few examples. In a particular implementation, wireless transceiver 521 may transmit signals on an uplink channel and receive signals on a downlink channel as discussed above. In one implementation, wireless transceiver 521 may transmit messages to one or more base stations in an uplink communication channel and receive messages in a downlink communication channel comprising TPC commands as discussed above.

Mobile device 500 may also comprise SPS receiver 555 capable of receiving and acquiring SPS signals 559 via SPS antenna 558 (which may be integrated with antenna 522 in some embodiments). SPS receiver 555 may also process, in whole or in part, acquired SPS signals 559 for estimating a location of mobile device 500. In some embodiments, general-purpose processor(s) 511, memory 540, digital signal processor(s) (DSP(s)) 512 and/or specialized processors (not shown) may also be utilized to process acquired SPS signals 559, in whole or in part, and/or calculate an estimated location of mobile device 500, in conjunction with SPS receiver 555. Storage of SPS or other signals (e.g., signals acquired from wireless transceiver 521) or storage of measurements of these signals for use in performing positioning operations may be performed in memory 540 or registers (not shown). General-purpose processor(s) 511, memory 540, DSP(s) 512 and/or specialized processors may provide or support a location engine for use in processing measurements to estimate a location of mobile device 500. In a particular implementation, all or portions of actions or operations set forth for process 500 may be executed by general-purpose processor(s) 511 or DSP(s) 512 based on machine-readable instructions stored in memory 540.

Also shown in FIG. 5, digital signal processor(s) (DSP(s)) 512 and general-purpose processor(s) 511 may be connected to memory 540 through bus 501. A particular bus interface (not shown) may be integrated with the DSP(s) 512, general-purpose processor(s) 511 and memory 540. In various embodiments, functions may be performed in response to execution of one or more machine-readable instructions stored in memory 540 such as on a computer-readable storage medium, such as RAM, ROM, FLASH, or disc drive, just to name a few examples. The one or more instructions may be executable by general-purpose processor(s) 511, specialized processors, or DSP(s) 512. Memory 540 may comprise a non-transitory processor-readable memory and/or a computer-readable memory that stores software code (programming code, instructions, etc.) that are executable by processor(s) 511 and/or DSP(s) 512 to perform functions or actions described above in connection with FIG. 4.

Also shown in FIG. 5, a user interface 535 may comprise any one of several devices such as, for example, a speaker, microphone, display device, vibration device, keyboard, touch screen, just to name a few examples. In a particular implementation, user interface 535 may enable a user to interact with one or more applications hosted on mobile device 500. For example, devices of user interface 535 may store analog or digital signals on memory 540 to be further processed by DSP(s) 512 or general purpose processor 511 in response to actions from a user. Similarly, applications hosted on mobile device 500 may store analog or digital signals on memory 540 to present an output signal to a user. In another implementation, mobile device 500 may optionally include a dedicated audio input/output (I/O) device 570 comprising, for example, a dedicated speaker, microphone, digital to analog circuitry, analog to digital circuitry, amplifiers and/or gain control. It should be understood, however, that this is merely an example of how an audio I/O may be implemented in a mobile device, and that claimed subject matter is not limited in this respect. In another implementation, mobile device 500 may comprise touch sensors 562 responsive to touching or pressure on a keyboard or touch screen device.

Mobile device 500 may also comprise a dedicated camera device 564 for capturing still or moving imagery. Camera device 564 may comprise, for example an imaging sensor (e.g., charge coupled device or CMOS imager), lens, analog to digital circuitry, frame buffers, just to name a few examples. In one implementation, additional processing, conditioning, encoding or compression of signals representing captured images may be performed at general purpose/application processor 511 or DSP(s) 512. Alternatively, a dedicated video processor 568 may perform conditioning, encoding, compression or manipulation of signals representing captured images. Additionally, video processor 568 may decode/decompress stored image data for presentation on a display device (not shown) on mobile device 500.

Mobile device 500 may also comprise sensors 560 coupled to bus 501 which may include, for example, inertial navigation sensors and environment sensors. Inertial navigation sensors of sensors 560 may comprise, for example accelerometers (e.g., collectively responding to acceleration of mobile device 500 in three dimensions), one or more gyroscopes or one or more magnetometers (e.g., to support one or more compass applications). Environment sensors of sensors 560 may comprise, for example, temperature sensors, barometric pressure sensors, ambient light sensors, camera imagers, microphones, just to name few examples. Sensors 560 may generate analog or digital signals that may be stored in memory 540 and processed by DPS(s) 512 or general purpose application processor 511 in support of one or more applications such as, for example, applications directed to positioning or navigation operations. In one example implementation, signals generated by measurements or signals from inertial navigation sensors of sensors 560 may be combined with TPC commands as described above to locate a base station.

In a particular implementation, mobile device 500 may comprise a dedicated modem processor 566 capable of performing baseband processing of signals received and downconverted at wireless transceiver 521 or SPS receiver 555. Similarly, modem processor 566 may perform baseband processing of signals to be upconverted for transmission by wireless transceiver 521. In alternative implementations, instead of having a dedicated modem processor, baseband processing may be performed by a general purpose processor or DSP (e.g., general purpose/application processor 511 or DSP(s) 512). It should be understood, however, that these are merely examples of structures that may perform baseband processing, and that claimed subject matter is not limited in this respect.

As used herein, the terms “mobile device” and “user equipment” (UE) are used synonymously to refer to a device that may from time to time have a location that changes. The changes in location may comprise changes to direction, distance, orientation, etc., as a few examples. In particular examples, a mobile device may comprise a cellular telephone, wireless communication device, user equipment, laptop computer, other personal communication system (PCS) device, personal digital assistant (PDA), personal audio device (PAD), portable navigational device, and/or other portable communication devices. A mobile device may also comprise a processor and/or computing platform adapted to perform functions controlled by machine-readable instructions.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, or combinations thereof.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing circuit having a command set which includes the encoded commands. Such an instruction may be encoded in the form of a machine language understood by the processing circuit. Again, these are merely examples of an instruction and claimed subject matter is not limited in this respect.

“Storage medium” as referred to herein relates to media capable of maintaining expressions which are perceivable by one or more machines. For example, a storage medium may comprise one or more storage devices for storing machine-readable instructions or information. Such storage devices may comprise any one of several media types including, for example, magnetic, optical or semiconductor storage media. Such storage devices may also comprise any type of long term, short term, volatile or non-volatile memory devices. However, these are merely examples of a storage medium, and claimed subject matter is not limited in these respects.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, or any combination of the above networks, and so on. A CDMA network may implement one or more radio access technologies (RATs) such as cdma2000, Wideband CDMA (WCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and WCDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. 4G Long Term Evolution (LTE) and 5G or New Radio (NR) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a small cell or femtocell, utilized to extend cellular telephone service (e.g. into a business or home). In such an implementation, one or more mobile devices may communicate with a femtocell via a code division multiple access (CDMA) or LTE cellular communication protocol, for example, and the femtocell may provide the mobile device access to a larger cellular telecommunication network by way of another broadband network such as the Internet.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

What is claimed is:

1. A method, at a mobile device, comprising:
transmitting first messages to a plurality of base stations;
receiving second messages from the plurality of base stations, the second messages comprising transmission power control (TPC) parameters, the TPC parameters being based, at least in part on measurements of received signal power for the first messages obtained at the base stations; and
determining one or more parameters indicative of a first motion of the mobile device based, at least in part, on the TPC parameters.

2. The method of claim 1, wherein the one or more parameters indicative of the first motion comprise one or more parameters indicative of a change in location, a speed, a velocity, a straight line distance, a direction, a movement toward one of the plurality of base stations, a movement away from one of the plurality of base stations, or a movement at a constant distance from one of the plurality of base stations, or some combination thereof.

3. The method of claim 1, wherein the plurality of base stations comprise a plurality of evolved NodeB transceiver devices for Long Term Evolution Carrier Aggregation or a plurality of NR NodeB (gNB) transceiver devices for New Radio (NR) Carrier Aggregation, and wherein the TPC parameters comprise TPC bits.

4. The method of claim 1, wherein the mobile device further comprises one or more inertial navigation sensors, the method further comprising:
determining one or more parameters indicative of a second motion of the mobile device based on the inertial navigation sensors; and
determining one or more parameters indicative of a location of at least one of the plurality of base stations based, at least in part, on the one or more parameters indicative of the first motion and the one or more parameters indicative of the second motion.

5. The method of claim 4, wherein the one or more parameters indicative of the location of the at least one of the plurality of base stations comprise a direction, a distance, a relative location or an absolute location, or a combination thereof.

6. The method of claim 4 and further comprising:
determining one or more parameters indicative of a third motion of the mobile device based, at least in part, on the location of the at least one of the plurality of base stations and the TPC parameters.

7. The method of claim 1, wherein the mobile device comprises an autonomous vehicle, wherein the method further comprises:
determining that a predetermined travel path for the autonomous vehicle is to change in response to a condition or event;
characterizing movement of the autonomous vehicle toward or away from one or more of the base stations based on the TPC parameters; and
updating the predetermined travel path based, at least in part, on the characterized movement of the autonomous vehicle.

8. The method of claim 1, and further comprising:
determining a location of the mobile device based, at least in part, on the one or more parameters indicative of the first motion.

9. A mobile device, comprising:
a transceiver to transmit messages to and receive messages from a communication network; and
one or more processors configured to:
initiate transmission of first messages to a plurality of base stations;
obtain from second messages received at the transceiver from the plurality of base stations transmission power control (TPC) parameters, the TPC parameters being based, at least in part on measurements of received signal power for the first messages obtained at the base stations; and
determine one or more parameters indicative of a first motion of the mobile device based, at least in part, on the TPC parameters.

10. The mobile device of claim 9, wherein the one or more parameters indicative of the first motion comprise one or more parameters indicative of a change in location, a speed, a velocity, a straight line distance, a direction, a movement toward one of the plurality of base stations, a movement away from one of the plurality of base stations, or a movement at a constant distance from one of the plurality of base stations, or some combination thereof.

11. The mobile device of claim 9, wherein the plurality of base stations comprise a plurality of evolved NodeB transceiver devices for Long Term Evolution Carrier Aggregation or a plurality of NR NodeB (gNB) transceiver devices for New Radio (NR) Carrier Aggregation, and wherein the TPC parameters comprise TPC bits.

12. The mobile device of claim 9, wherein the mobile device further comprises one or more inertial navigation sensors, and wherein the one or more processors are further configured to:
determine one or more parameters indicative of a second motion of the mobile device based on the inertial navigation sensors; and
determine one or more parameters indicative of a location of at least one of the plurality of base stations based, at least in part, on the one or more parameters indicative of the first motion and the one or more parameters indicative of the second motion.

13. The mobile device of claim 12, wherein the one or more parameters indicative of the location of the at least one of the plurality of base stations comprise a direction, a distance, a relative location or an absolute location, or a combination thereof.

14. The mobile device of claim 12, wherein the one or more processors are further configured to:
determine one or more parameters indicative of a third motion of the mobile device based, at least in part, on the location of the at least one of the plurality of base stations and the TPC parameters.

15. The mobile device of claim 9, wherein the mobile device comprises an autonomous vehicle, and wherein the one or more processors are further configured to:
determine that a predetermined travel path for the autonomous vehicle is to change in response to a condition or event;
characterize movement of the autonomous vehicle toward or away from one or more of the base stations based on the TPC parameters; and
update the predetermined travel path based, at least in part, on the characterized movement of the autonomous vehicle.

16. The mobile device of claim 9, wherein the one or more processors are further configured to:
determine a location of the mobile device based, at least in part, on the one or more parameters indicative of the first motion.

17. A storage medium comprising computer readable instructions stored thereon which are executable by one or more processors of a mobile device to:
initiate transmission of first messages to a plurality of base stations;
obtain from second messages received at the mobile device from the plurality of base stations transmission power control (TPC) parameters, the TPC parameters being based, at least in part on measurements of received signal power for the first messages obtained at the base stations; and
determine one or more parameters indicative of a first motion of the mobile device based, at least in part, on the TPC parameters.

18. The storage medium of claim 17, wherein the one or more parameters indicative of the first motion comprise one or more parameters indicative of a change in location, a speed, a velocity, a straight line distance, a direction, a movement toward one of the plurality of base stations, a movement away from one of the plurality of base stations, or a movement at a constant distance from one of the plurality of base stations, or some combination thereof.

19. The storage medium of claim 17, wherein the plurality of base stations comprise a plurality of evolved NodeB transceiver devices for Long Term Evolution Carrier Aggregation or a plurality of NR NodeB (gNB) transceiver devices for New Radio (NR) Carrier Aggregation, and wherein the TPC parameters comprise TPC bits.

20. The storage medium of claim 17, wherein the mobile device further comprises one or more inertial navigation sensors, and wherein the instructions are further executable by the one or more processors to:
determine one or more parameters indicative of a second motion of the mobile device based on the inertial navigation sensors; and
determine one or more parameters indicative of a location of at least one of the plurality of base stations based, at least in part, on the one or more parameters indicative of the first motion and the one or more parameters indicative of the second motion.

21. The storage medium of claim 20, wherein the one or more parameters indicative of the location of the at least one of the plurality of base stations comprise a direction, a distance, a relative location or an absolute location, or a combination thereof.

22. The storage medium of claim 20, wherein the instructions are further executable by the one or more processors to:
determine one or more parameters indicative of a third motion of the mobile device based, at least in part, on the location of the at least one of the plurality of base stations and the TPC parameters.

23. The storage medium of claim 17, wherein the instructions are further executable by the one or more processors to:
determine a location of the mobile device based, at least in part, on the one or more parameters indicative of the first motion.

24. A mobile device, comprising:
means for transmitting first messages to a plurality of base stations;
means for receiving second messages from the plurality of base stations, the second messages comprising transmission power control (TPC) parameters, the TPC parameters being based, at least in part on measurements of received signal power for the first messages obtained at the base stations; and
means for determining one or more parameters indicative of a first motion of the mobile device based, at least in part, on the TPC parameters.

25. The mobile device of claim 24, wherein the one or more parameters indicative of the first motion comprise one or more parameters indicative of a change in location, a speed, a velocity, a straight line distance, a direction, a movement toward one of the plurality of base stations, a movement away from one of the plurality of base stations, or a movement at a constant distance from one of the plurality of base stations, or some combination thereof.

26. The mobile device of claim 24, wherein the plurality of base stations comprise a plurality of evolved NodeB transceiver devices for Long Term Evolution Carrier Aggregation or a plurality of NR NodeB (gNB) transceiver devices for New Radio (NR) Carrier Aggregation, and wherein the TPC parameters comprise TPC bits.

27. The mobile device of claim 24, wherein the mobile device further comprises one or more inertial navigation sensors, and wherein the mobile device further comprises:
means for determining one or more parameters indicative of a second motion of the mobile device based on the inertial navigation sensors; and
means for determining one or more parameters indicative of a location of at least one of the plurality of base stations based, at least in part, on the one or more parameters indicative of the first motion and the one or more parameters indicative of the second motion.

28. The mobile device of claim 27, wherein the one or more parameters indicative of the location of the at least one of the plurality of base stations comprise a direction, a distance, a relative location or an absolute location, or a combination thereof.

29. The mobile device of claim 27, and further comprising:
means for determining one or more parameters indicative of a third motion of the mobile device based, at least in part, on the location of the at least one of the plurality of base stations and the TPC parameters.

30. The mobile device of claim 24, and further comprising:
means for determining a location of the mobile device based, at least in part, on the one or more parameters indicative of the first motion.
